(19) United States
(12) Patent Application Publication
(10) Pub. No.: US 2007/0180703 A1
(43) Pub. Date: Aug. 9, 2007

(54) Hair removal device

(76) Inventors: Diana B. Sierra, Fairview, NJ (US); Adriana Kliegman, York, NY (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/349,033

(22) Filed: Feb. 7, 2006

(51) Int. Cl. B26B 3/00

(52) U.S. Cl. 30/169

(57) ABSTRACT

A hair removal device or razor is disclosed for use with a depilatory cream in removing unwanted hair. The razor may be a bladeless razor. The razor of the present invention has a flexible applicator edge for evenly spreading the cream on skin over body contours without unwanted contact to user's skin in an area other than the application area. Once cream has processed, it is removed with a head region of razor having a scraping edge at an opposite end of the razor. The head region has low sidewalls that form a scoop shape for containing removed cream during cream removal. Also on the scraping edge is at least one bladelike strip of high friction material for gripping hair and pulling it during the removal of the cream to remove the hair at the same time.

### TECHNICAL FIELD OF THE INVENTION

The invention relates to a hair removal device and more particularly relates to a bladeless razor for use in applying depilatory cream and subsequently removing the depilatory cream with unwanted hair.

### BACKGROUND

Certain hair removal devices are known in the art. Most common hair removal devices are razors with cutting blades, electric razors with cutting blades, and depilatory creams for chemically removing hair. Also known in the art are certain bladeless razors used in conjunction with depilatory creams for removing the cream after its chemical processing has occurred. Bladeless razors are desirable for reducing a user's contact with the chemical depilatory cream on areas other than the treated area and assisting in removing the cream and unwanted hair. Due to the desire to have limited skin contact with depilatory cream, gloves are provided with some creams to reduce contact between the hands and the cream during the application and removal process. However, the cream is difficult to apply evenly, and application of the cream with the hands, whether gloved or not, results in not only uneven application of the cream, but also creates a mess.

### SUMMARY OF THE INVENTION

A bladeless razor for use in spreading and removing depilatory cream and hair from an application area is provided. For example, a bladeless razor is provided with a flexible applicator edge and a different edge for removing cream with a high friction material that forms a “razor” edge to grip and remove hair while cream is scraped from application area. The razor may have one wide edge for applying the cream. The wide edge may be flexible for an even application. As known in the art, the depilatory cream is chemically engineered to dissolve or remove hair, and therefore, it can be irritable to skin. Such creams may utilize compounds that include potassium thioglycolate, however, other compounds may also be used. Therefore, a user may desire to limit any unnecessary contact with the cream when possible. The applicator edge of the disclosed device allows a user to apply the cream from its package to the applicator, then use the applicator to apply the cream to the application area. Alternatively, the user could apply the cream directly from its package to the application area, then use the applicator edge of the present invention to evenly spread the cream. Once the cream has been on the application area for the recommended time for activation, the “razor edge” or scraping edge of the hair removal device is useful for removing the cream and unwanted hair. The body of the hair removal device may comprise sidewalls that form a scoop shape to hold cream while removing it from the application area. This scoop feature prevents cream from spilling out of the sides of the scraping edge, and limits application area to the user's designated application area. Further, one or more bladelike strips made of a high friction material on the scraping edge are configured to grip hair and remove it while the cream is being removed. The present invention can be various sizes for various treatment areas, i.e. a smaller version of the hair removal device may be useful for treating facial hair, while a larger version of the invention may be used for treating the leg area.

In one embodiment, a bladeless razor configured for applying and removing cream, such as depilatory cream, has a head region with a scraping edge having at least one blade like edge made of flexible high friction material. The razor also has an applicator region at an opposite end from the head region having a wide flexible edge to facilitate spreading of cream. In use, depilatory cream is applied with the applicator region. The applicator region may be made of flexible material for evenly spreading cream over body contours. Once the depilatory cream has processed, the cream is removed with the scraping edge of the head region. In one embodiment, the scraping edge of the head region may be preferably held at a 110 degree angle or more to a ground surface, i.e. the user's skin, for removing cream and unwanted hair. The head region has low side walls creating a retention region or pocket for holding removed cream and preventing cream from spilling out of sides of razor. As described below, other features and variations can be implemented, if desired, and a related method can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a perspective view of the underside of the hair removal device showing a double-blade like edge.

FIGS. 2A-2B are cross-sections of the hair removal device with a double-blade or single-blade like edge.

FIG. 3 shows a side view of the hair removal device.

FIGS. 4A-4B show the underside and topside of the. hair removal device respectively of the present invention.

FIG. 5 shows a side view of the hair removal device with the blade positioned at a 90 degree angle to the skin to illustrate the correct position of the attachment of the blade.

FIG. 6 shows a side view of the hair removal device in use at an at least 110 degree angle to the skin for hair removal.

FIG. 7 is a perspective view of the top of the hair removal device.

### DETAILED DESCRIPTION OF THE INVENTION

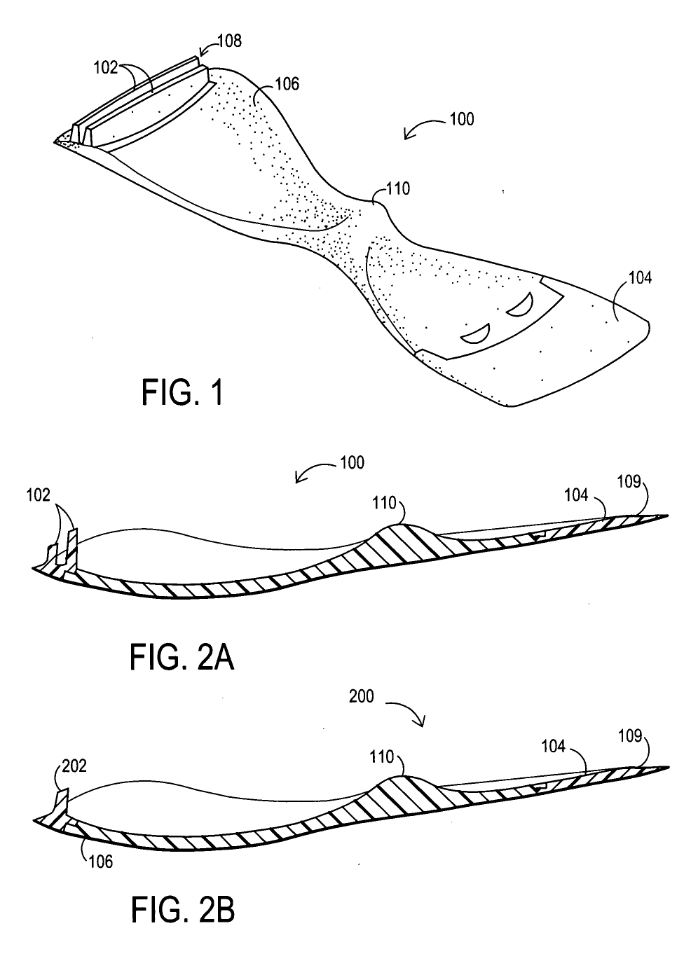

A hair removal device or razor is disclosed that is configured to apply and remove cream, such as depilatory cream. Referring to the drawings, FIG. 1 shows the underside of one embodiment of the hair removal device or razor 100. The hair removal razor 100 may have an applicator region 104 with a wide edge to facilitate spreading depilatory cream during the cream application process. As known in the art, the depilatory cream may be chemically engineered to dissolve or remove hair, and therefore, it can be irritable to skin. Such creams may utilize compounds that include potassium thioglycolate, however, other compounds may also be used. Once the cream has been on a user's skin for the recommended processing time, the cream is removed with an opposite end of the razor, i.e. a head region 106. While various creams may be applied with the applicator region 104, an exemplary embodiment of the present invention comprises spreading depilatory cream for hair removal with a bladeless razor, i.e. a razor with no cutting edge. The head region 106 has a scraping edge 108. While the razor 100 may have only one row or “blade” of high friction material, the scraping edge 108 of FIG. 1 has double-blade like edges 102 of high friction material configured to grip hair while hair and cream are removed. Though shown in FIG. 1 with double scraping edges, the razor 100 may be configured with a single scraping edge or with more than two scraping edges. In the embodiment of FIG. 1, the head region 106 is at an opposite end of the razor body from the applicator region 104.

FIGS. 2A-2B shows a cross-section (through section line 2-2 of FIG. 4A) of one embodiment of a hair removal device or razor 100. FIG. 2A shows a cross-section of the double scraping edge embodiment of hair removal device 100 shown in FIG. 1. The hair removal device 200 of FIG. 2B may have the same configuration as the hair removal device 100 of FIG. 1 except as shown in FIG. 2B, the device is provided with a single blade like scraping edge 202 so as to illustrate a single edge embodiment. The devices of FIGS. 1, 2A and 2B may include a protrusion region 110 on the underside of the body of the hair removal device that is useful for forming a gripping location to engage a users hand. The blade like scraping edges 102 and 202 may be made of a relatively high friction material (as compared to typical plastics and thermoplastics), such as a thermoplastic elastomer (for example Santoprene). In addition, Santoprene does not become relatively slippery when wet (as compared to many common rubbers which exhibit a higher slipping when wet). The use of Santoprene also enables the scrapping edge to be soft enough to somewhat flex with body contact, reducing skin irritation when removing the cream. Other materials may be utilized and though in one embodiment a high friction material may be preferable, the scraping edge material need not be a high friction material. The scrapping edges 102 and 202 grip hair for removal when the edges are scraped against skin. Applicator region 104 has an applicator surface 109 for spreading cream. The applicator region 104 may be made of a flexible material such as for example Santoprene for spreading cream evenly on skin over various body contours during application of a cream. It will be recognized that other materials may also be utilized for making the the applicator region, including non-flexible materials. The body of the razor between the applicator region and the head region may be formed of harder material, for example a polypropylene. Polypropylene also exhibits beneficial bonding properties with Santoprene. In an alternative embodiment, all the regions of the razor may be formed of the same material, such as for example, a hard plastic to reduce costs and simplify manufacturing.

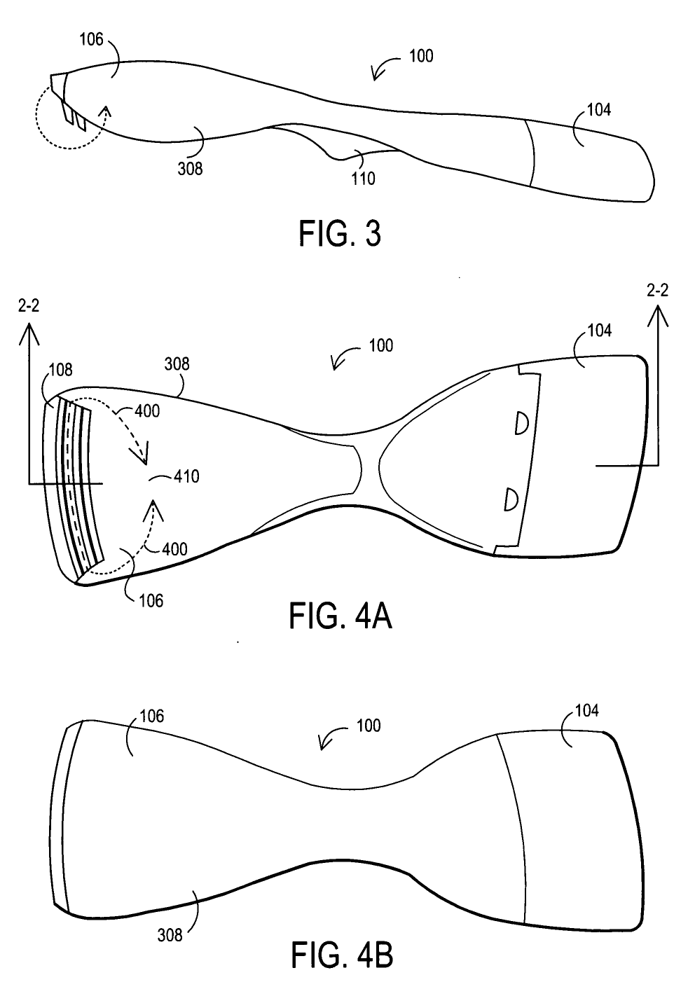

FIG. 3 shows a side view of one embodiment of the hair removal device or razor 100. As shown in FIG. 3, sidewalls 308 extend down each side of the razor 100. With reference to FIGS. 1-3, it can be seen that the extension of the sidewalls 308 form a dome. like pocket or scoop region on the underside of the hair removal device or razor 100 that acts as a cream retention region. The sidewalls 308 from a region that helps channel and hold the cream into scoop during cream removal.

FIG. 4A shows the underside of one embodiment of the hair removal device or razor 100. The arrows 400 show how the cream is directed or channeled into a retention region during cream removal by the side walls 308 of the head region 106 that extend down from main body of the razor. The curvature of the tip of the head region 106 also assists in the channeling action. By channel the used cream into the retention region, cream is less likely to escape around the edges of the razor and being displaced to another part of the user's skin. As cream is removed and accumulated in the retention region, the user may then periodically clean or wash the retention region so that the entire cream removal process is achieved in simpler, yet more controlled manner. FIG. 4B shows a topside view of the hair removal device 100. FIGS. 4A-4B, show one embodiment of the razor wherein both ends are wide. The narrower region between both wide ends provides an ergonomically designed region for assisting in gripping the razor. It will be recognized that other configurations may be utilized and the concepts disclosed herein are not limited to use with such an embodiment. The main body of the hair removal device is configured to hold cream during cream removal by scraping edge 108 of head region 106.

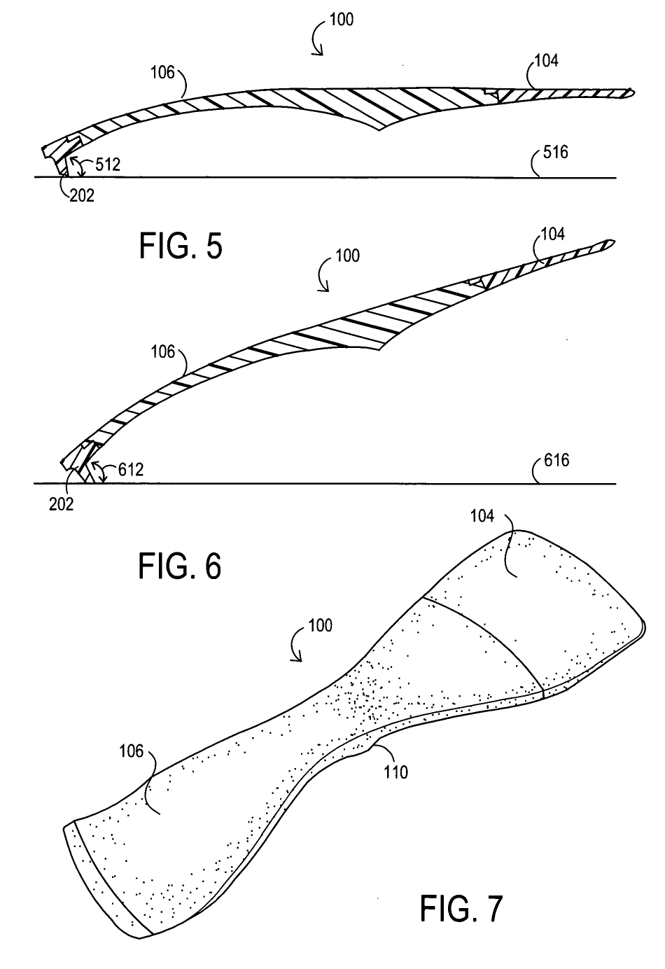

FIGS. 5 and 6 show one exemplary embodiment of the angle of the scraping edge 202 of the hair removal device or razor 100. As shown in FIG. 5, blade 102 is attached to the head region 106 such that when the main razor body is roughly parallel with to a ground plan/skin surface 516 an approximately 90 degree angle 512 is formed between the scraping edge 102 and the ground plan/skin surface 516. By forming such an angle, when the hair removal device or razor 100 is utilized by a user in a natural position the angle between the scraping edge and the skin is greater than 90 degrees. FIG. 6 shows an embodiment of the hair removal device razor 100 at a natural position in use wherein the blade 202 of the head region 106 is at approximately a 110 degree angle 612 to a ground plane/skin surface 616. This angle ensures blade edge is in full contact with user's skin and digs into hair follicles to effectively remove hair. It is desirable that the front edge of the blade contact the skin as shown in FIG. 6 when in a natural use position. To help ensure such contact the blade may flex slightly so that as the angle of the tool increase with regard to the skin plane, the leading edge still makes contact with the skin. It will be recognized that the concepts disclosed herein, may however, be beneficially utilized with other angles.

FIG. 7 illustrates a top perspective view of the hair removal device or razor 100 and its associated head region 106 and applicator region 104 having a protrusion region 110 on the underside of the body of the hair removal device or razor 100.

Thus, there is a provided a single unitary device that may be utilized for application of hair removal products, such as depilatory cream, and for removal of the cream/hair. An applicator region may be formed on one end of the device and a razor scraping edge may be formed on the other end of the device. The device may be a bladeless razor. The single unitary device may be formed of materials of differing compositions so as to provide enhanced structures for application and hair removal. The body of the device may be formed in a manner such that some hair removal cream may be retained in a retention pocket so as improve the ease of use of the device and catch the removed cream in a manner that also limits the spreading of the cream during the removal process. The razor may also be formed in an ergonomic manner that eases the gripping of the razor while still providing a desirable size for the applicator region and the scraping edge.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A razor for use with applying and removing cream, the razor comprising:
a head region with a scraping edge; and
an applicator region at an opposite end from the head region, the applicator region having a surface configured to facilitate spreading of cream.

2. The razor of claim 1 wherein the cream is a depilatory cream.

3. The razor of claim 2 wherein the razor is a bladeless razor.

4. The razor of claim 3 further comprising a high friction material on the scraping edge, the high friction material configured to remove hair while removing cream.

5. The razor of claim 1 wherein the head region has one scraping edge row.

6. The razor of claim 1 wherein the head region comprises more than one scraping edge row.

7. The razor of claim 1 wherein the applicator region is comprised of a flexible material.

8. The razor of claim 7 wherein the scraping edge is comprised of a high friction material.

9. The razor of claim 8 wherein the head region comprises a retention region configured for collecting removed cream.

10. The razor of claim 1 wherein the head region comprises a retention region configured for collecting removed cream.

11. A bladeless razor for use with cream, comprising:
a head region with a bladeless scraping edge;
an applicator region at an opposite end of the head region; and
a central region with an elongated body between the head region and the applicator region, the razor having at least one end wider than at least at least a portion of the central region.

12. The bladeless razor of claim 11 wherein the cream is depilatory cream.

13. The bladeless razor of claim 12 wherein both ends are wide.

14. The bladeless razor of claim 12 further comprising side walls extending down from the head region and configured to create a retention region to hold cream during cream removal.

15. The bladeless razor of claim 14 configured so that the scraping edge has greater than a 110 degree angle between blade and skin during use.

16. The bladeless razor of claim 14 wherein the scraping edge comprises one or more rows of a high friction material.

17. The bladeless razor of claim 14 wherein applicator region is comprised of a flexible material.

18. A razor for use with depilatory cream, comprising:
a head region with a bladeless scraping edge;
an flexible applicator region; and
a central region with elongated body between the head region and the applicator region, the applicator region and head region being located at opposite ends of the central region.

19. The razor of claim 18 wherein said scraping edge comprises a two or more rows of scraping edges.

20. The razor of claim 18 wherein the scraping edge comprises one or more rows of high friction material attached at a 90 degree angle to a ground surface.

21. The razor of claim 18 wherein central region comprises a protrusion configured to assist gripping of a users hand.

22. The razor of claim 18 further comprising a retention region for holding removed cream.
